(19) United States
(12) Patent Application Publication
(10) Pub. No.: US 2025/0139510 A1
(43) Pub. Date: May 1, 2025

(54) System, Method, and Computer Program Product for Tuning Prediction Results of Machine Learning Models

(71) Applicant: Visa International Service Association, San Francisco, CA (US)

(72) Inventor: Pei Yang, Austin, TX (US)

(21) Appl. No.: 18/693,651

(22) PCT Filed: Sep. 21, 2021
(86) PCT No.: PCT/US21/51212

§ 371 Date: Mar. 20, 2024

(51) Int. Cl. G06N 20/00

(52) U.S. Cl. CPC G06N 20/00

(57) ABSTRACT

Provided are systems for tuning prediction results of a machine learning model that include at least one processor to determine a plurality of values associated with a prediction matrix based on an output of a trained machine learning model, tune a set of reference measures to provide an adjustment to a predicted classification value of a prospective output of the trained machine learning model, apply the set of reference measures to determine a predicted classification value of a real-time output of the trained machine learning model, wherein the output of the trained machine learning model comprises a predicted classification value for a real-time event. Methods and computer program products are also provided.

### CROSS REFERENCE TO RELATED APPLICATION

This application is the United States national phase of International Application No. PCT/US2021/051212 filed Sep. 21, 2021, the entire disclosure of which is hereby incorporated by reference in its entirety.

### BACKGROUND

### 1. Technical Field

This disclosure relates generally to machine learning and, in some non-limiting embodiments or aspects, to systems, methods, and computer program products for tuning prediction results of a machine learning model.

### 2. Technical Considerations

Machine learning may refer to a field of computer science that uses statistical techniques to provide a computer system with the ability to learn (e.g., to progressively improve performance of) a task with data without the computer system being explicitly programmed to perform the task. In some instances, a machine learning model may be developed for a set of data so that the machine learning model may perform a task (e.g., a task associated with a prediction) with regard to the set of data.

In some instances, a machine learning model, such as a predictive machine learning model, may be used to make a prediction regarding a risk or an opportunity based on a large amount of data (e.g., a large scale dataset). A predictive machine learning model may be used to analyze a relationship between the performance of a unit based on a large scale dataset associated with the unit and one or more known features of the unit. The objective of the predictive machine learning model may be to assess the likelihood that a similar unit will exhibit the same or similar performance as the unit. In order to generate the predictive machine learning model, the large scale dataset may be segmented so that the predictive machine learning model may be trained on data that is appropriate.

In some instances, multiclass classification (e.g., multinomial classification) may refer to a problem of classifying instances into one of three or more classes, whereas classifying instances into one of two classes may be referred to as binary classification.

Deep learning (e.g., deep structured learning) may refer to a category of machine learning algorithms based on artificial neural networks with representation learning, where the representation learning may be supervised, semi-supervised, and/or unsupervised. Machine learning architectures that are used for deep learning may include deep neural networks (DNNs), deep belief networks, deep reinforcement learning, recurrent neural networks, and convolutional neural networks.

A deep learning model may be used for classification/prediction tasks in a variety of applications, such as facial recognition, fraud detection, disease diagnosis, and navigation of self-driving cars, and/or the like. In such applications, the deep learning model may receive an input and generate predictions based on the input, for example, the identity of an individual, whether an action is fraudulent or not fraudulent, whether a disease is associated with one or more genetic markers, whether an object in a field of view of a self-driving car is in the self-driving car's path, and/or the like.

### SUMMARY

Accordingly, disclosed are improved systems, methods, and computer program products for tuning prediction results of a machine learning model.

According to some non-limiting embodiments or aspects, provided is a system comprising: at least one processor programmed or configured to: determine a plurality of values associated with a prediction matrix based on a first output of a trained machine learning model, wherein the plurality of values associated with the prediction matrix are values representing an error value between a predicted classification value for each event of a plurality of events and a ground truth value for each event of the plurality of events, wherein the plurality of values associated with the prediction matrix comprise: upper error values for the plurality of events and lower error values for the plurality of events, wherein the upper error values comprise error values associated with the predicted classification value for the plurality of events being greater than the ground truth value for the plurality of events, and wherein the lower error values comprise error values associated with the predicted classification value for the plurality of events being less than the ground truth value for the plurality of events; tune a set of reference measures to provide an adjustment to a predicted classification value of a prospective output of the trained machine learning model, wherein, when tuning the set of reference measures to provide the adjustment to the predicted classification value of the prospective output of the trained machine learning model, the at least one processor is programmed or configured to: adjust the predicted classification value of the prospective output of the trained machine learning model to reduce one or more lower error values in the plurality of values associated with the prediction matrix; and apply the set of reference measures to determine a predicted classification value of a second output of the trained machine learning model, wherein the second output of the trained machine learning model comprises a prediction for an event.

According to some non-limiting embodiments or aspects, provided is a computer program product comprising at least one non-transitory computer-readable medium including one or more instructions that, when executed by at least one processor, cause the at least one processor to: determine a plurality of values associated with a prediction matrix based on a first output of a trained machine learning model, wherein the plurality of values associated with the prediction matrix are values representing an error value between a predicted classification value for each event of a plurality of events and a ground truth value for each event of the plurality of events, wherein the plurality of values associated with the prediction matrix comprise: upper error values for the plurality of events and lower error values for the plurality of events, wherein the upper error values comprise error values associated with the predicted classification value for the plurality of events being greater than the ground truth value for the plurality of events, and wherein the lower error values comprise error values associated with the predicted classification value for the plurality of events being less than the ground truth value for the plurality of events; tune a set of reference measures to provide an adjustment to a predicted classification value of a prospective output of the trained machine learning model, wherein the one or more instructions that cause the at least one processor to tune the set of reference measures to provide the adjustment to the predicted classification value of the prospective output of the trained machine learning model, cause the at least one processor to: adjust the predicted classification value of the prospective output of the trained machine learning model to reduce one or more lower error values in the plurality of values associated with the prediction matrix; and apply the set of reference measures to determine a predicted classification value of a second output of the trained machine learning model, wherein the second output of the trained machine learning model comprises a prediction for an event.

According to some non-limiting embodiments, provided is a computer-implemented method comprising: determining, with at least one processor, a plurality of values associated with a prediction matrix based on a first output of a trained machine learning model, wherein the plurality of values associated with the prediction matrix are values representing an error value between a predicted classification value for each event of a plurality of events and a ground truth value for each event of the plurality of events, wherein the plurality of values associated with the prediction matrix comprise: upper error values for the plurality of events and lower error values for the plurality of events, wherein the upper error values comprise error values associated with the predicted classification value for the plurality of events being greater than the ground truth value for the plurality of events, and wherein the lower error values comprise error values associated with the predicted classification value for the plurality of events being less than the ground truth value for the plurality of events; tuning, with the at least one processor, a set of reference measures to provide an adjustment to a predicted classification value of a prospective output of the trained machine learning model, wherein tuning the set of reference measures to provide the adjustment to the predicted classification value of the prospective output of the trained machine learning model comprises: adjusting the predicted classification value of the prospective output of the trained machine learning model to reduce one or more lower error values in the plurality of values associated with the prediction matrix; and applying the set of reference measures to determine a predicted classification value of a second output of the trained machine learning model, wherein the second output of the trained machine learning model comprises a prediction for an event.

Further non-limiting embodiments or aspects are set forth in the following numbered clauses:

Clause 1: A system, comprising: at least one processor programmed or configured to: determine a plurality of values associated with a prediction matrix based on a first output of a trained machine learning model, wherein the plurality of values associated with the prediction matrix are values representing an error value between a predicted classification value for each event of a plurality of events and a ground truth value for each event of the plurality of events, wherein the plurality of values associated with the prediction matrix comprise: upper error values for the plurality of events and lower error values for the plurality of events, wherein the upper error values comprise error values associated with the predicted classification value for the plurality of events being greater than the ground truth value for the plurality of events, and wherein the lower error values comprise error values associated with the predicted classification value for the plurality of events being less than the ground truth value for the plurality of events; tune a set of reference measures to provide an adjustment to a predicted classification value of a prospective output of the trained machine learning model, wherein, when tuning the set of reference measures to provide the adjustment to the predicted classification value of the prospective output of the trained machine learning model, the at least one processor is programmed or configured to: adjust the predicted classification value of the prospective output of the trained machine learning model to reduce one or more lower error values in the plurality of values associated with the prediction matrix; and apply the set of reference measures to determine a predicted classification value of a second output of the trained machine learning model, wherein the second output of the trained machine learning model comprises a prediction for an event.

Clause 2: The system of clause 1, wherein the set of reference measures comprises a reference measure vector with a set of values, wherein the second output of the trained machine learning model comprises an output vector with a set of values, and wherein, when applying the set of reference measures to determine the predicted classification value of the second output of the trained machine learning model, the at least one processor is programmed or configured to: multiply the set of values of the output vector by the set of values of the reference measure vector to provide an adjusted output vector.

Clause 3: The system of clause 1 or 2, wherein the at least one processor is further programmed or configured to: determine the predicted classification value of the second output of the trained machine learning model based on the adjusted output vector.

Clause 4: The system of any of clauses 1-3, wherein the at least one processor is further programmed or configured to: train a multi-class deep learning model based on a training dataset used to generate the trained machine learning model, wherein the training dataset comprises a plurality of data instances associated with the plurality of events.

Clause 5: The system of any of clauses 1-4, wherein the set of reference measures comprises a number of values that is equal to a number of a plurality of class labels associated with the second output of the trained machine learning model.

Clause 6: The system of any of clauses 1-5, wherein each reference measure in the set of reference measures has a value between 0 and 1, and wherein values of the reference measures in the set of reference measures are equal to 1 when summed together.

Clause 7: The system of any of clauses 1-6, wherein the at least one processor is further programmed or configured to: calculate a lower error rate based on the upper error values for the plurality of events, the lower error values for the plurality of events, and correct prediction values for the plurality of events; and wherein, when tuning the set of reference measures to provide the adjustment to the predicted classification value of the prospective output of the trained machine learning model, the at least one processor is programmed or configured to: tune the set of reference measures to provide the adjustment to the predicted classification value of the prospective output of the trained machine learning model based on the lower error rate.

Clause 8: A computer program product comprising at least one non-transitory computer-readable medium including one or more instructions that, when executed by at least one processor, cause the at least one processor to: determine a plurality of values associated with a prediction matrix based on a first output of a trained machine learning model, wherein the plurality of values associated with the prediction matrix are values representing an error value between a predicted classification value for each event of a plurality of events and a ground truth value for each event of the plurality of events, wherein the plurality of values associated with the prediction matrix comprise: upper error values for the plurality of events and lower error values for the plurality of events, wherein the upper error values comprise error values associated with the predicted classification value for the plurality of events being greater than the ground truth value for the plurality of events, and wherein the lower error values comprise error values associated with the predicted classification value for the plurality of events being less than the ground truth value for the plurality of events; tune a set of reference measures to provide an adjustment to a predicted classification value of a prospective output of the trained machine learning model, wherein the one or more instructions that cause the at least one processor to tune the set of reference measures to provide the adjustment to the predicted classification value of the prospective output of the trained machine learning model, cause the at least one processor to: adjust the predicted classification value of the prospective output of the trained machine learning model to reduce one or more lower error values in the plurality of values associated with the prediction matrix; and apply the set of reference measures to determine a predicted classification value of a second output of the trained machine learning model, wherein the second output of the trained machine learning model comprises a prediction for an event.

Clause 9: The computer program product of clause 8, wherein the set of reference measures comprises a reference measure vector with a set of values, wherein the second output of the trained machine learning model comprises an output vector with a set of values, and wherein the one or more instructions that cause the at least one processor to apply the set of reference measures to determine the predicted classification value of the second output of the trained machine learning model, cause the at least one processor to: multiply the set of values of the output vector by the set of values of the reference measure vector to provide an adjusted output vector.

Clause 10: The computer program product of clause 8 or 9, wherein the one or more instructions further cause the at least one processor to: determine the predicted classification value of the second output of the trained machine learning model based on the adjusted output vector.

Clause 11: The computer program product of any of clauses 8-10, wherein the one or more instructions further cause the at least one processor to: train a multi-class deep learning model based on a training dataset used to generate the trained machine learning model, wherein the training dataset comprises a plurality of data instances associated with the plurality of events.

Clause 12: The computer program product of any of clauses 8-11, wherein the set of reference measures comprises a number of values that is equal to a number of a plurality of class labels associated with the second output of the trained machine learning model.

Clause 13: The computer program product of any of clauses 8-12, wherein each reference measure in the set of reference measures has a value between 0 and 1, and wherein values of the reference measures in the set of reference measures are equal to 1 when summed together.

Clause 14: The computer program product of any of clauses 8-13, wherein the one or more instructions further cause the at least one processor to: calculate a lower error rate based on the upper error values for the plurality of events, the lower error values for the plurality of events, and correct prediction values for the plurality of events; and wherein the one or more instructions that cause the at least one processor to tune the set of reference measures to provide the adjustment to the predicted classification value of the prospective output of the trained machine learning model, cause the at least one processor to: tune the set of reference measures to provide the adjustment to the predicted classification value of the prospective output of the trained machine learning model based on the lower error rate.

Clause 15: A method, comprising: determining, with at least one processor, a plurality of values associated with a prediction matrix based on a first output of a trained machine learning model, wherein the plurality of values associated with the prediction matrix are values representing an error value between a predicted classification value for each event of a plurality of events and a ground truth value for each event of the plurality of events, wherein the plurality of values associated with the prediction matrix comprise: upper error values for the plurality of events and lower error values for the plurality of events, wherein the upper error values comprise error values associated with the predicted classification value for the plurality of events being greater than the ground truth value for the plurality of events, and wherein the lower error values comprise error values associated with the predicted classification value for the plurality of events being less than the ground truth value for the plurality of events; tuning, with the at least one processor, a set of reference measures to provide an adjustment to a predicted classification value of a prospective output of the trained machine learning model, wherein tuning the set of reference measures to provide the adjustment to the predicted classification value of the prospective output of the trained machine learning model comprises: adjusting the predicted classification value of the prospective output of the trained machine learning model to reduce one or more lower error values in the plurality of values associated with the prediction matrix; and applying the set of reference measures to determine a predicted classification value of a second output of the trained machine learning model, wherein the second output of the trained machine learning model comprises a prediction for an event.

Clause 16: The method of clause 15, wherein the set of reference measures comprises a reference measure vector with a set of values, wherein the second output of the trained machine learning model comprises an output vector with a set of values, and wherein applying the set of reference measures to determine the predicted classification value of the second output of the trained machine learning model comprises: multiplying the set of values of the output vector by the set of values of the reference measure vector to provide an adjusted output vector.

Clause 17: The method of clause 15 or 16, further comprising: determining the predicted classification value of the second output of the trained machine learning model based on the adjusted output vector.

Clause 18: The method of any of clauses 15-17, further comprising: training, with the at least one processor, a multi-class deep learning model based on a training dataset used to generate the trained machine learning model, wherein the training dataset comprises a plurality of data instances associated with the plurality of events.

Clause 19: The method of any of clauses 15-18, wherein the set of reference measures comprises a number of values that is equal to a number of a plurality of class labels associated with the second output of the trained machine learning model.

Clause 20: The method of any of clauses 15-19, further comprising: calculating, with the at least one processor, a lower error rate based on the upper error values for the plurality of events, the lower error values for the plurality of events, and correct prediction values for the plurality of events; and wherein tuning the set of reference measures to provide the adjustment to the predicted classification value of the prospective output of the trained machine learning model comprises: tuning the set of reference measures to provide the adjustment to the predicted classification value of the prospective output of the trained machine learning model based on the lower error rate.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a diagram of a non-limiting embodiment or aspect of an environment in which systems, devices, products, apparatus, and/or methods, described herein, may be implemented according to the principles of the present disclosure;

FIG. 2 is a diagram of a non-limiting embodiment or aspect of components of one or more devices and/or one or more systems of FIG. 1;

FIG. 3 is a flowchart of a non-limiting embodiment or aspect of a process for tuning prediction results of a machine learning model; and

FIGS. 4A-4E are diagrams of non-limiting embodiments or aspects of an implementation of a process for tuning prediction results of a machine learning model.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects of the embodiments disclosed herein are not to be considered as limiting unless otherwise indicated.

Some non-limiting embodiments or aspects may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some non-limiting embodiments or aspects, a message may refer to a network packet (e.g., a data packet and/or the like) that includes data.

As used herein, the terms “issuer,” “issuer institution,” “issuer bank,” or “payment device issuer,” may refer to one or more entities that provide accounts to individuals (e.g., users, customers, and/or the like) for conducting payment transactions, such as credit payment transactions and/or debit payment transactions. For example, an issuer institution may provide an account identifier, such as a primary account number (PAN), to a customer that uniquely identifies one or more accounts associated with that customer. In some non-limiting embodiments or aspects, an issuer may be associated with a bank identification number (BIN) that uniquely identifies the issuer institution. As used herein, the term “issuer system” may refer to one or more computer systems operated by or on behalf of an issuer, such as a server executing one or more software applications. For example, an issuer system may include one or more authorization servers for authorizing a transaction.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa®, MasterCard®, American Express®, or any other entity that processes transactions. As used herein, the term “transaction service provider system” may refer to one or more computer systems operated by or on behalf of a transaction service provider, such as a transaction service provider system executing one or more software applications. A transaction service provider system may include one or more processors and, in some non-limiting embodiments or aspects, may be operated by or on behalf of a transaction service provider.

As used herein, the term “merchant” may refer to one or more entities (e.g., operators of retail businesses) that provide goods and/or services, and/or access to goods and/or services, to a user (e.g., a customer, a consumer, and/or the like) based on a transaction, such as a payment transaction. As used herein, the term “merchant system” may refer to one or more computer systems operated by or on behalf of a merchant, such as a server executing one or more software applications. As used herein, the term “product” may refer to one or more goods and/or services offered by a merchant.

As used herein, the term “acquirer” may refer to an entity licensed by the transaction service provider and approved by the transaction service provider to originate transactions (e.g., payment transactions) involving a payment device associated with the transaction service provider. As used herein, the term “acquirer system” may also refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting embodiments or aspects, the acquirer may be authorized by the transaction service provider to assign merchant or service providers to originate transactions involving a payment device associated with the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by the acquirer's payment facilitators, and/or the like. In some non-limiting embodiments or aspects, an acquirer may be a financial institution, such as a bank.

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like operated by or on behalf of a payment gateway.

As used herein, the terms “client” and “client device” may refer to one or more computing devices, such as processors, storage devices, and/or similar computer components, that access a service made available by a server. In some non-limiting embodiments or aspects, a client device may include a computing device configured to communicate with one or more networks and/or facilitate transactions such as, but not limited to, one or more desktop computers, one or more portable computers (e.g., tablet computers), one or more mobile devices (e.g., cellular phones, smartphones, personal digital assistant, wearable devices, such as watches, glasses, lenses, and/or clothing, and/or the like), and/or other like devices. Moreover, the term “client” may also refer to an entity that owns, utilizes, and/or operates a client device for facilitating transactions with another entity.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

In some instances, a machine learning model may be used to classify an occurrence of an event. For example, a machine learning model may be used to predict an amount of time that may pass from an initial point in time until the occurrence of the event. In such an example, the prediction provided by the machine learning model may include a probably that the occurrence of the event will take place within different time periods after the initial point in time. Ultimately, the predictions of the machine learning model may be compared to ground truth values that are actual (e.g., real, true, etc.) measures of the amount of time that passed from the initial point in time until the occurrence of the event. A prediction matrix (e.g., a confusion matrix) may be generated that includes values that represent the error rates between predictions of the machine learning model and the ground truth values.

However, based on inputs, the machine learning model may predict the amount of time that may pass from the initial point in time until the occurrence of the event as an underestimate and as an overestimate. However, in some instances, an underestimate or an overestimate may be an inaccurate result based on the particular use of the machine learning model. Furthermore, when using a trained machine learning model, there is not a way to adjust the output of the trained machine learning model without retraining the machine learning model. In such an instance, retraining the machine learning model may require obtaining a new training dataset to produce a machine learning model that provides a desired prediction.

Provided are systems, methods, and computer program products for tuning prediction results of a machine learning model. Embodiments of the present disclosure may include a machine learning prediction system that includes at least one processor programmed or configured to determine a plurality of values associated with a prediction matrix based on a first output of a trained machine learning model, wherein the plurality of values associated with the prediction matrix are values representing an error value between a predicted classification value for each event of a plurality of events and a ground truth value for each event of the plurality of events, wherein the plurality of values associated with the prediction matrix comprise: upper error values for the plurality of events and lower error values for the plurality of events, wherein the upper error values comprise error values associated with the predicted classification value for the plurality of events being greater than the ground truth value for the plurality of events, and wherein the lower error values comprise error values associated with the predicted classification value for the plurality of events being less than the ground truth value for the plurality of events; tune a set of reference measures to provide an adjustment to a predicted classification value of a prospective output of the trained machine learning model, wherein, when tuning the set of reference measures to provide the adjustment to the predicted classification value of the prospective output of the trained machine learning model, the at least one processor is programmed or configured to: adjust the predicted classification value of the prospective output of the trained machine learning model to reduce one or more lower error values in the plurality of values associated with the prediction matrix; and apply the set of reference measures to determine a predicted classification value of a second output, such as a real-time output, of the trained machine learning model, wherein the output of the trained machine learning model comprises a prediction for an event, such as a real-time event.

In some non-limiting embodiments or aspects, the set of reference measures comprises a reference measure vector with a set of values, the second output of the trained machine learning model comprises an output vector with a set of values, and, when applying the set of reference measures to determine the predicted classification value of the second output of the trained machine learning model, the at least one processor is programmed or configured to multiply the set of values of the output vector by the set of values of the reference measure vector to provide an adjusted output vector. In some non-limiting embodiments or aspects, the at least one processor is further programmed or configured to determine the predicted classification value of the second output of the trained machine learning model based on the adjusted output vector. In some non-limiting embodiments or aspects, the at least one processor is further programmed or configured to train a multi-class deep learning model based on a training dataset used to generate the trained machine learning model, the training dataset comprises a plurality of data instances associated with the plurality of events.

In some non-limiting embodiments or aspects, the set of reference measures comprises a number of values that is equal to a number of a plurality of class labels associated with the second output of the trained machine learning model. In some non-limiting embodiments or aspects, each reference measure in the set of reference measures has a value between 0 and 1, and wherein values of the reference measures in the set of reference measures are equal to 1 when summed together. In some non-limiting embodiments or aspects, the at least one processor is further programmed or configured to calculate a lower error rate based on the upper error values for the plurality of events, the lower error values for the plurality of events, and correct prediction values for the plurality of events, and, when tuning the set of reference measures to provide the adjustment to the predicted classification value of the prospective output of the trained machine learning model, the at least one processor is programmed or configured to tune the set of reference measures to provide the adjustment to the predicted classification value of the prospective output of the trained machine learning model based on the lower error rate.

In this way, embodiments or aspects of the present disclosure allow for a system to provide an accurate prediction according to a desired outcome for an event. In addition, embodiments or aspects of the present disclosure eliminate the need to retrain a machine learning model to obtain the accurate prediction. As such, the techniques described herein may reduce and/or eliminate the requirements for computational resources associated with retraining a machine learning model to provide an accurate prediction according to the desired outcome for the event.

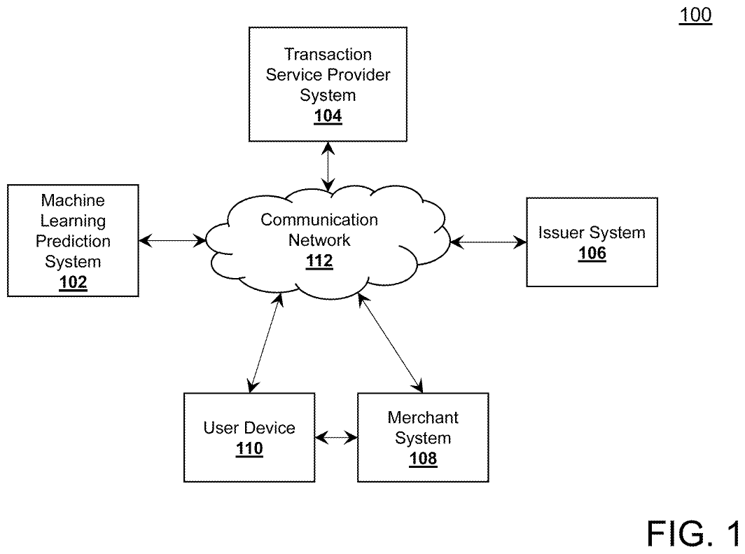

Referring now to FIG. 1, FIG. 1 is a diagram of an example environment 100 in which devices, systems, methods, and/or products described herein may be implemented. As shown in FIG. 1, environment 100 includes machine learning prediction system 102, transaction service provider system 104, issuer system 106, merchant system 108, and user device 110. Machine learning prediction system 102, transaction service provider system 104, issuer system 106, merchant system 108, and user device 110 may interconnect (e.g., establish a connection to communicate, and/or the like) via wired connections, wireless connections, or a combination of wired and wireless connections.

Machine learning prediction system 102 may include one or more computing devices configured to communicate with transaction service provider system 104, issuer system 106, merchant system 108, and/or user device 110 via communication network 112. For example, machine learning prediction system 102 may include a group of servers and/or other like devices. In some non-limiting embodiments or aspects, machine learning prediction system 102 may be associated with (e.g., operated by) a transaction service provider, as described herein. Additionally or alternatively, machine learning prediction system 102 may be a component of transaction service provider system 104.

Transaction service provider system 104 may include one or more computing devices configured to communicate with machine learning prediction system 102, issuer system 106, merchant system 108, and/or user device 110 via communication network 112. For example, transaction service provider system 104 may include a group of servers and/or other like devices. In some non-limiting embodiments or aspects, transaction service provider system 104 may be associated with (e.g., operated by) a transaction service provider, as described herein. In some non-limiting embodiments, transaction service provider system 104 may be associated with an entity (e.g., a transaction service provider) that operates a credit card network and that processes payments for credit accounts, debit accounts, credit cards, debit cards, and/or the like. In some non-limiting embodiments or aspects, transaction service provider system 104 may be in communication with a data storage device, which may be local or remote to the transaction service provider system 104. In some non-limiting embodiments or aspects, transaction service provider system 104 may be capable of receiving information from, storing information in, communicating information to, or searching information stored in the data storage device. In some non-limiting embodiments or aspects, transaction service provider system 104 may include machine learning prediction system 102. For example, machine learning prediction system 102 may be a component of transaction service provider system 104.

Issuer system 106 may include one or more computing devices configured to communicate with machine learning prediction system 102, transaction service provider system 104, merchant system 108, and/or user device 110 via communication network 112. For example, issuer system 106 may include a server, a group of servers, and/or other like devices. In some non-limiting embodiments or aspects, issuer system 106 may be associated with (e.g., operated by) an issuer, as described herein.

Merchant system 108 may include one or more computing devices configured to communicate with machine learning prediction system 102, transaction service provider system 104, issuer system 106, and/or user device 110 via communication network 112. For example, merchant system 108 may include a server, a group of servers, a client device, and/or other like devices. In some non-limiting embodiments or aspects, merchant system 108 may be associated with (e.g., operated by) a merchant, as described herein. Additionally or alternatively, merchant system 108 may include a device capable of being in communication with user device 110 via a communication connection (e.g., a near field communication (NFC) connection, a radio frequency identification (RFID) communication connection, a Bluetooth® communication connection, etc.) with user device 110. In some non-limiting embodiments or aspects, merchant system 108 may include user device 110. For example, merchant system 108 may include user device 110 that allows a merchant to communicate information to transaction service provider system 104.

User device 110 may include one or more computing devices configured to communicate with machine learning prediction system 102, transaction service provider system 104, issuer system 106, and/or merchant system 108 via communication network 112. For example, user device 110 may include a desktop computer (e.g., a client device that communicates with a server), a mobile device, and/or the like. User device 110 may be configured to communicate with merchant system 108 via a short-range wireless communication connection (e.g., an NFC communication connection, an RFID communication connection, a Bluetooth® communication connection, and/or the like). In some non-limiting embodiments or aspects, user device 110 may be associated with a user (e.g., an individual operating a device).

Communication network 112 may include one or more wired and/or wireless networks. For example, communication network 112 may include a cellular network (e.g., a long-term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of some or all of these or other types of networks.

The number and arrangement of systems and/or devices shown in FIG. 1 are provided as an example. There may be additional systems and/or devices, fewer systems and/or devices, different systems and/or devices, or differently arranged systems and/or devices than those shown in FIG. 1. Furthermore, two or more systems and/or devices shown in FIG. 1 may be implemented within a single system or a single device, or a single system or a single device shown in FIG. 1 may be implemented as multiple, distributed systems or devices. Additionally or alternatively, a set of systems or a set of devices (e.g., one or more systems, one or more devices) of environment 100 may perform one or more functions described as being performed by another set of systems or another set of devices of environment 100.

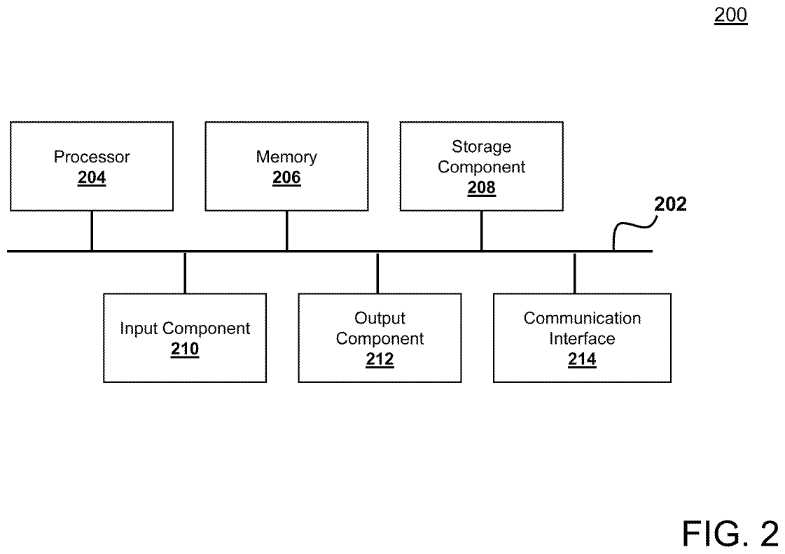

Referring now to FIG. 2, FIG. 2 is a diagram of example components of device 200. Device 200 may correspond to machine learning prediction system 102 (e.g., one or more devices of machine learning prediction system 102), transaction service provider system 104, issuer system 106, merchant system 108, and/or user device 110. In some non-limiting embodiments or aspects, machine learning prediction system 102, transaction service provider system 104, issuer system 106, merchant system 108, and/or user device 110 may include at least one device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments or aspects, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touchscreen display, a keyboard, a keypad, a mouse, a button, a switch, a microphone, a camera, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a Bluetooth® interface, a Zigbee® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software.

Memory 206 and/or storage component 208 may include data storage or one or more data structures (e.g., a database and/or the like). Device 200 may be capable of receiving information from, storing information in, communicating information to, or searching information stored in the data storage or one or more data structures in memory 206 and/or storage component 208. For example, the information may include input data, output data, transaction data, account data, or any combination thereof.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

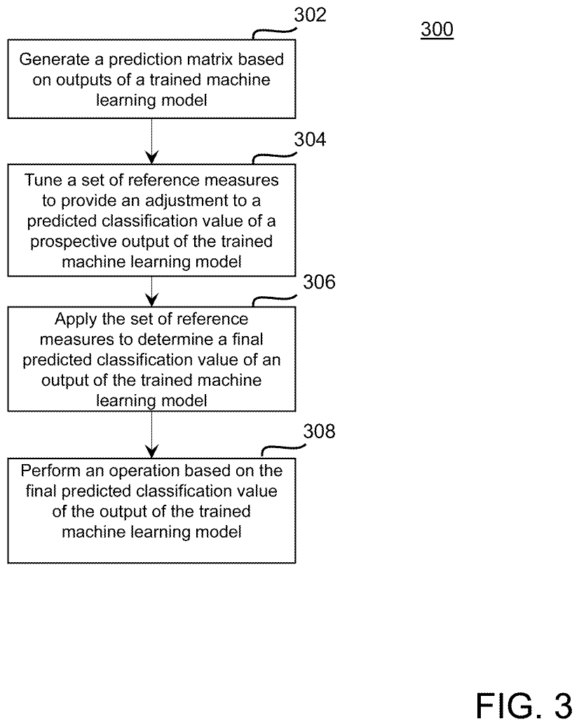

Referring now to FIG. 3, FIG. 3 is a flowchart of a non-limiting embodiment or aspect of a process 300 for tuning prediction results of a machine learning model. In some non-limiting embodiments or aspects, one or more of the functions described with respect to process 300 may be performed (e.g., completely, partially, etc.) by machine learning prediction system 102. In some non-limiting embodiments or aspects, one or more of the steps of process 300 may be performed (e.g., completely, partially, and/or the like) by another device or a group of devices separate from or including machine learning prediction system 102, such as transaction service provider system 104, issuer system 106, merchant system 108, and/or user device 110.

As shown in FIG. 3, at step 302, process 300 may include generating a prediction matrix based on outputs of a trained machine learning model. For example, machine learning prediction system 102 may generate the prediction matrix (e.g., confusion matrix, error matrix, etc.) based on outputs of the trained machine learning model. In some non-limiting embodiments or aspects, the prediction matrix may include a matrix comparing a plurality of ground truth values (e.g., a plurality of actual classification values, which include actual values of classifications) for a plurality of data instances of a dataset with a plurality of predicted classification values (e.g., predictions of values of classifications) for the plurality of data instances of the dataset. In some non-limiting embodiments or aspects, the plurality of predicted classification values may be based on an output (e.g., a first output) of the trained machine learning model. In some non-limiting embodiments or aspects, the dataset may include a training dataset (e.g., a dataset used to train a machine learning model to provide the trained machine learning model) for the trained machine learning model.

In some non-limiting embodiments or aspects, each data instance of the plurality of data instances of the dataset may represent an event, such as an electronic payment transaction (e.g., an electronic credit card payment transaction, an electronic debit card payment transaction, etc.) between a user associated with user device 110 and a merchant associated with merchant system 108. In some non-limiting embodiments or aspects, each data instance may include transaction data associated with the electronic payment transaction. In some non-limiting embodiments or aspects, transaction data may include transaction parameters associated with an electronic payment transaction. Transaction parameters may include electronic wallet card data associated with an electronic card (e.g., an electronic credit card, an electronic debit card, an electronic loyalty card, and/or the like), decision data associated with a decision (e.g., a decision to approve or deny a transaction authorization request), authorization data associated with an authorization response (e.g., an approved spending limit, an approved transaction value, and/or the like), a PAN, an authorization code (e.g., a PIN, etc.), data associated with a transaction amount (e.g., an approved limit, a transaction value, etc.), data associated with a transaction date and time, data associated with a conversion rate of a currency, data associated with a merchant type (e.g., goods, grocery, fuel, and/or the like), data associated with an acquiring institution country, data associated with an identifier of a country associated with the PAN, data associated with a response code, data associated with a merchant identifier (e.g., a merchant name, a merchant location, and/or the like), data associated with a type of currency corresponding to funds stored in association with the PAN, and/or the like.

In some non-limiting embodiments or aspects, the predicted classification values may include an amount of time associated with the event. For example, the predicted classification values may represent an amount of time taken to complete the event. In one example, the predicted classification values may represent an amount of time (e.g., a number of days) taken to clear (e.g., a process that involves activities that turn the promise of payment, such as in the form of an electronic payment request, into an actual movement of electronic funds from one account to another) an electronic payment transaction between a user associated with user device 110 and a merchant associated with merchant system 108.

In some non-limiting embodiments or aspects, machine learning prediction system 102 may generate the plurality of values associated with the prediction matrix based on outputs of the trained machine learning model. For example, machine learning prediction system 102 may provide each data instance of the dataset as input to the trained machine learning model, and machine learning prediction system 102 may generate an output of the trained machine learning model for each data instance of the dataset as an input.

In some non-limiting embodiments or aspects, machine learning prediction system 102 may determine a classification (e.g., a predicted classification, an initial predicted classification, and/or the like) of each data instance of the dataset. For example, machine learning prediction system 102 may determine the classification of the initial input by providing the initial input to the trained machine learning model (e.g., a trained machine learning model that includes a random forest, a multilayer perceptron, and/or a neural network, such as a deep neural network) and determine the classification as an output from the machine learning model. In some non-limiting embodiments or aspects, the trained machine learning model may be a machine learning classifier that includes a deep learning network. In some non-limiting embodiments or aspects, the classification may be associated with a class that includes a group of members, and the classification may refer to a characteristic that is shared among the members of the group in the class. In some non-limiting embodiments or aspects, machine learning prediction system 102 may store the training dataset in a database.

In some non-limiting embodiments or aspects, each value of the plurality of values associated with the prediction matrix may include a value representing an error value between a predicted classification value (e.g., an amount of time, such as a number of days) for one or more data instances and a ground truth value for the one or more data instances. The values of the prediction matrix may include an error value between a first ground truth value for one or more data instances and a first predicted classification value for the one or more data instances, an error value between a second ground truth value for one or more data instances and the first predicted classification value for the one or more data instances, an error value between the first ground truth value for one or more data instances and a second predicted classification value for the one or more data instances, an error value between a third ground truth value for one or more data instances and the first predicted classification value for the one or more data instances, an error value between the first ground truth value for one or more data instances and a third predicted classification value for the one or more data instances, an error value between the third ground truth value for one or more data instances and the second predicted classification value for the one or more data instances, an error value between the second ground truth value for one or more data instances and the third predicted classification value for the one or more data instances, and so on. In some non-limiting embodiments or aspects, the plurality of values associated with the prediction matrix may include upper error values (e.g., upper diagonal error values) for a plurality of events and lower error values (e.g., lower diagonal error values) for the plurality of events. In some non-limiting embodiments or aspects, the upper error values comprise error values associated with the predicted classification value for the event being greater than the ground truth value for the event. In some non-limiting embodiments or aspects, the lower error values may include error values associated with the predicted classification value for the event being less than the ground truth value for the event. In some non-limiting embodiments or aspects, the plurality of values associated with the prediction matrix may include correct prediction values, which may include values associated with the predicted classification value for the event being equal to the ground truth value for the event.

In some non-limiting embodiments or aspects, machine learning prediction system 102 may generate the trained machine learning model. For example, machine learning prediction system 102 may generate the trained machine learning model to provide a predicted classification of a data instance, such as a data instance associated with an event, based on the training dataset.

In some non-limiting embodiments or aspects, the trained machine learning model may include a machine learning model designed to receive, as an input, data instances associated with events, and provide, as an output, a predicted classification of the data instances. In some non-limiting embodiments, machine learning prediction system 102 may store the trained machine learning model (e.g., for later use).

In some non-limiting embodiments or aspects, as described herein, machine learning prediction system 102 may process data instances associated with events (e.g., historical data instances associated with events) to obtain training data (e.g., a training dataset) for the machine learning model. For example, machine learning prediction system 102 may process the data to change the data into a format that may be analyzed (e.g., by machine learning prediction system 102) to generate the trained machine learning model. The data that is changed (e.g., the data that results from the change) may be referred to as training data. In some non-limiting embodiments or aspects, machine learning prediction system 102 may process the data instances associated with events to obtain the training data based on receiving the data instances. Additionally or alternatively, machine learning prediction system 102 may process the data to obtain the training data based on machine learning prediction system 102 receiving an indication, from a user (e.g., a user associated with user device 110) of machine learning prediction system 102, that machine learning prediction system 102 is to process the data, such as when machine learning prediction system 102 receives an indication to generate a machine learning model for predicting a classification of an event.

In some non-limiting embodiments or aspects, machine learning prediction system 102 may process data instances associated with events by determining a prediction variable based on the data. A prediction variable may include a metric, associated with events, which may be derived based on the data instances associated with events. The prediction variable may be analyzed to generate a trained machine learning model. For example, the prediction variable may include a variable associated with a time of an event, a variable associated with a parameter of an event, a variable associated with a number of occurrences of an aspect of an event, and/or the like.

In some non-limiting embodiments or aspects, machine learning prediction system 102 may analyze the training data to generate the trained machine learning model. For example, machine learning prediction system 102 may use machine learning techniques to analyze the training data to generate the trained machine learning model. In some non-limiting embodiments or aspects, generating the trained machine learning model (e.g., based on training data) may be referred to as training a machine learning model. The machine learning techniques may include, for example, supervised and/or unsupervised techniques, such as decision trees, random forests, logistic regressions, linear regression, gradient boosting, support-vector machines, extra-trees (e.g., an extension of random forests), Bayesian statistics, learning automata, Hidden Markov Modeling, linear classifiers, quadratic classifiers, association rule learning, and/or the like. In some non-limiting embodiments or aspects, the machine learning model may include a model that is specific to a particular characteristic, for example, a model that is specific to a particular entity involved in an event, a particular time interval during which an event occurred, and/or the like. Additionally or alternatively, the machine learning model may be specific to particular entities (e.g., business entities, such as a merchants, consumer entities, such as account holders of accounts issued by issuers, issuers, etc.) that are involved in the events. In some non-limiting embodiments or aspects, machine learning prediction system 102 may generate one or more trained machine learning models for one or more entities, a particular group of entities, and/or one or more users of one or more entities.

Additionally or alternatively, when analyzing the training data, machine learning prediction system 102 may identify one or more variables (e.g., one or more independent variables) as predictor variables (e.g., features) that may be used to make a prediction when analyzing the training data. In some non-limiting embodiments or aspects, values of the predictor variables may be inputs to a machine learning model. For example, machine learning prediction system 102 may identify a subset (e.g., a proper subset) of the variables as the predictor variables that may be used to accurately predict a classification of an event. In some non-limiting embodiments or aspects, the predictor variables may include one or more of the prediction variables, as discussed above, that have a significant impact (e.g., an impact satisfying a threshold) on a predicted classification of an event as determined by machine learning prediction system 102.

In some non-limiting embodiments or aspects, machine learning prediction system 102 may validate a machine learning model. For example, machine learning prediction system 102 may validate the machine learning model after machine learning prediction system 102 generates the machine learning model. In some non-limiting embodiments or aspects, machine learning prediction system 102 may validate the machine learning model based on a portion of the training data to be used for validation. For example, machine learning prediction system 102 may partition the training data into a first portion and a second portion, where the first portion may be used to generate the machine learning model, as described above. In this example, the second portion of the training data (e.g., the validation data) may be used to validate the machine learning model.

In some non-limiting embodiments or aspects, machine learning prediction system 102 may validate the machine learning model by providing validation data associated with a user (e.g., data associated with one or more events involving a user) as input to the machine learning model, and determining, based on an output of the machine learning model, whether the machine learning model correctly, or incorrectly, predicted a classification of an event. In some non-limiting embodiments or aspects, machine learning prediction system 102 may validate the machine learning model based on a validation threshold. For example, machine learning prediction system 102 may be configured to validate the machine learning model when the classifications of a plurality of events (as identified by the validation data) are correctly predicted by the machine learning model (e.g., when the machine learning model correctly predicts 50% of the classifications of a plurality of events, 70% of the classifications of a plurality of events, a threshold quantity of the classifications of a plurality of events, and/or the like).

In some non-limiting embodiments or aspects, if machine learning prediction system 102 does not validate the machine learning model (e.g., when a percentage of correctly predicted classifications of a plurality of events does not satisfy the validation threshold), then machine learning prediction system 102 may generate one or more additional machine learning models.

In some non-limiting embodiments or aspects, once the machine learning model has been validated, machine learning prediction system 102 may further train the machine learning model and/or generate new machine learning models based on receiving new training data. The new training data may include additional data associated with one or more events. In some non-limiting embodiments or aspects, the new training data may include data associated with an additional plurality of events. Machine learning prediction system 102 may use the machine learning model to predict the classifications of the additional plurality of events and compare an output of a machine learning model to the new training data. In such an example, machine learning prediction system 102 may update one or more trained machine learning models based on the new training data.

In some non-limiting embodiments or aspects, machine learning prediction system 102 may store the trained machine learning model. For example, machine learning prediction system 102 may store the trained machine learning model in a data structure (e.g., a database, a linked list, a tree, and/or the like). The data structure may be located within machine learning prediction system 102 or external (e.g., remote from) machine learning prediction system 102.

As shown in FIG. 3, at step 304, process 300 may include tuning a set of reference measures to provide an adjustment to a predicted classification value of a prospective output of the trained machine learning model. For example, machine learning prediction system 102 may tune a set of reference measures to provide an adjustment to a predicted classification of the prospective output of the trained machine learning model. In some non-limiting embodiments or aspects, machine learning prediction system 102 may adjust the predicted classification value of the prospective output of the trained machine learning model to reduce one or more error values in the plurality of values associated with the prediction matrix. For example, machine learning prediction system 102 may adjust the predicted classification value of the prospective output of the trained machine learning model to reduce one or more lower error values or one or more upper error values in the plurality of values of the prediction matrix.

In some non-limiting embodiments or aspects, machine learning prediction system 102 may generate the set of reference measures. In some non-limiting embodiments or aspects, the set of reference measures may include a number of values that is equal to a number of a plurality of classifications (e.g., class labels) associated with the output of the trained machine learning model. In some non-limiting embodiments or aspects, each reference measure in the set of reference measures may have a value between 0 and 1. Additionally or alternatively, the values of the reference measures in the set of reference measures may be equal to 1 when summed together.

In some non-limiting embodiments or aspects, machine learning prediction system 102 may calculate a lower error rate associated with the lower error values for the plurality of events. For example, machine learning prediction system 102 may calculate a lower error rate based on the upper error values for the plurality of events, the lower error values for the plurality of events, and/or the correct prediction values for the plurality of events. In one example, according to the following equation:

$$Lower Error Rate = \frac{{\sum }_{ij} LE\_ij}{{\sum }_{ij} LE\_ij + {\sum }_{ij} CP\_ij + {\sum }_{ij} UE\_ij}$$

where ΣᵢⱼLE_ij is a sum of the lower error values for the plurality of events of the prediction matrix, ΣᵢⱼUE_ij is a sum of the upper error values for the plurality of events of the prediction matrix, and ΣᵢⱼCP_ij is a sum of the correct prediction values for the plurality of events of the prediction matrix.

In some non-limiting embodiments or aspects, machine learning prediction system 102 may calculate an upper error rate associated with the upper error values for the plurality of events. For example, machine learning prediction system 102 may calculate the upper error rate based on the upper error values for the plurality of events, the lower error values for the plurality of events, and/or the correct prediction values for the plurality of events. In one example, according to the following equation:

$$Upper Error Rate = \frac{{\sum }_{ij} UE\_ij}{{\sum }_{ij} LE\_ij + {\sum }_{ij} CP\_ij + {\sum }_{ij} UE\_ij}$$

In some non-limiting embodiments or aspects, machine learning prediction system 102 may use the lower error rate and/or the upper error rate to generate the set of reference measures. For example, machine learning prediction system 102 may generate the set of reference measures based on the lower error rate and/or the upper error rate. In some non-limiting embodiments or aspects, machine learning prediction system 102 may generate the set of reference measures to provide a bias that increases or reduces the lower error rate and/or the upper error rate.

In some non-limiting embodiments or aspects, machine learning prediction system 102 may tune the set of reference measures to provide an adjustment to the predicted class of the prospective output of the trained machine learning model based on the lower error rate and/or the upper error rate.

In some non-limiting embodiments or aspects, machine learning prediction system 102 may generate the set of reference measures by pre-defining a reference measure, Mᵢ, for each predicted classification value, i, in a N-class classification problem, as follows:

$$\{ \begin{matrix}0 < {M}_{i} < 1 \\ {M}_{0} + {M}_{1} + … + {M}_{N - 1} = 1\end{matrix}$$

In one example, the set of reference measures may include a vector (e.g., a reference measure vector) with a set of values:
{M₀, M₁, M₂, M₃}

In such an example, machine learning prediction system 102 may generate the set of values of the vector of the set of reference measures to reduce the lower error rate and/or the upper error rate by performing an operation (e.g., division, multiplication, etc.) on predicted classification values of the output of the trained machine learning:

$$\{ \frac{{P}_{0}}{{M}_{0}} , \frac{{P}_{1}}{{M}_{1}} , \frac{{P}_{2}}{{M}_{2}} , \frac{{P}_{3}}{{M}_{3}} \}$$

Each value of the set of values of the vector may be determined to adjust a predicted classification value of a prospective output of the trained machine learning model to reduce the lower error rate and/or the upper error rate.

For each data instance, machine learning prediction system 102 may use the trained machine learning model to provide an output, Pᵢ, for each classification, i. To determine which classification an event as an input should belong to (e.g., determine a final predicted classification value of an output based on an event as an input), machine learning prediction system 102 may select the highest value of according to the

$$\{ \frac{{P}_{i}}{{M}_{i}} \} ,$$

following equation:

$${Class}_{predicted} = {argmax}_{i} \{ \frac{{P}_{i}}{{M}_{i}} \} ( i = 0 , 1 , … , N - 1 )$$

As shown in FIG. 3, at step 306, process 300 may include applying the set of reference measures to determine a final predicted classification value of an output of the trained machine learning model. For example, machine learning prediction system 102 may apply the set of reference measures to determine the final predicted classification value of an output (e.g., a second output) of the trained machine learning model. In some non-limiting embodiments or aspects, the output, such as a real-time output (e.g., an output produced at a time when the trained machine learning model is deployed to make decisions with regard to a real-time event, an inference time output with regard to a real-time event, a runtime output with regard to a real-time event, etc.) of the trained machine learning model may include a predicted classification value for an event, such as a real-time event, (e.g., an event that is taking place, an event for which information is to be made available as or close to a time at which the event is happening, a live event, etc.), that is provided as an input. In some non-limiting embodiments or aspects, the output of the trained machine learning model may include a predicted classification value for the event, where that event is not an event associated with the data instance of the dataset used to train the trained machine learning model.

In some non-limiting embodiments or aspects, machine learning prediction system 102 may receive the data associated with the event, and machine learning prediction system 102 may provide the data associated with the event as the input to the trained machine learning model. Machine learning prediction system 102 may generate the output from the trained machine learning model based on the input. In some non-limiting embodiments or aspects, the output from the trained machine learning model may include a plurality of predicted classification values for the event. In some non-limiting embodiments or aspects, the output from the trained machine learning model may include a plurality of predicted classification values. The plurality of predicted classification values may include a predicted classification value for each classification (e.g., each class label) for which the trained machine learning model is configured to provide a prediction.

In some non-limiting embodiments or aspects, machine learning prediction system 102 may determine the final predicted classification value of the output of the trained machine learning model based on the output from the trained machine learning model and the set of reference measures. For example, machine learning prediction system 102 may determine the final predicted classification value of the output of the trained machine learning model based on applying the set of reference measures to a plurality of predicted classification values for the event (e.g., the output from the trained machine learning model that includes a plurality of predicted classification values for the event) to provide a plurality of adjusted predicted classification values for the event. In such an example, machine learning prediction system 102 may determine the final predicted classification value of the output based on an adjusted predicted classification value of the plurality of adjusted predicted classification values that has the highest value (e.g., the highest score). In some non-limiting embodiments or aspects, machine learning prediction system 102 may determine the adjusted predicted classification value of the output based on an adjusted predicted classification value of the plurality of adjusted predicted classification values that has the lowest value (e.g., the lowest score).

In some non-limiting embodiments or aspects, the output of the trained machine learning model may include an output vector with a set of values. In some non-limiting embodiments, machine learning prediction system 102 may multiply the set of values of the output vector by the set of values of the reference measure vector to provide an adjusted output vector. In some non-limiting embodiments or aspects, machine learning prediction system 102 may determine the final predicted classification value of the output of the trained machine learning model based on the adjusted output vector. For example, machine learning prediction system 102 may determine the final predicted classification value of the output based on a value of the set of values of the adjusted output vector that has the highest value.

As shown in FIG. 3, at step 308, process 300 may include performing an operation based on the final predicted classification value of the output of the trained machine learning model. For example, machine learning prediction system 102 may perform the operation based on the final predicted classification value of the output of the trained machine learning model. In some non-limiting embodiments or aspects, machine learning prediction system 102 may generate a report that includes data associated with the final predicted classification value of the output, and machine learning prediction system 102 may transmit the report. In some non-limiting embodiments or aspects, machine learning prediction system 102 may transmit the report to issuer system 106 and/or merchant system 108.

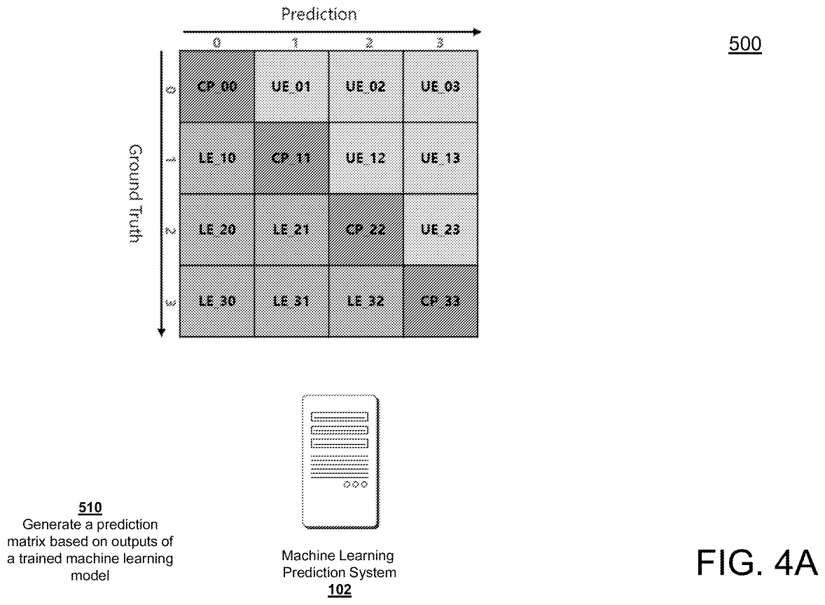

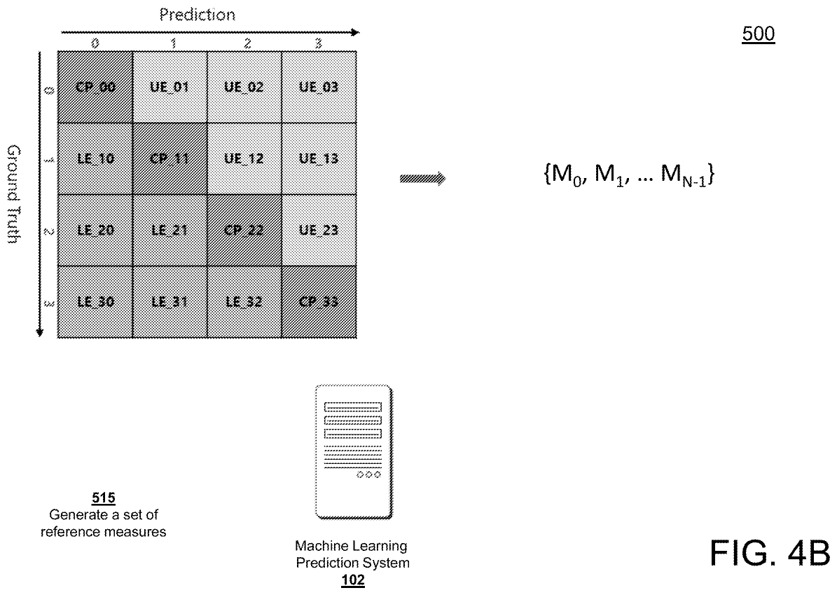

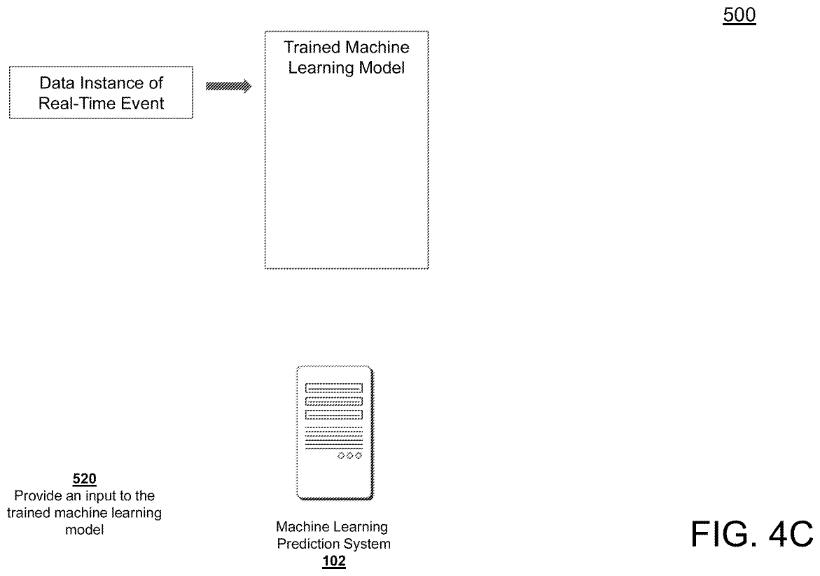

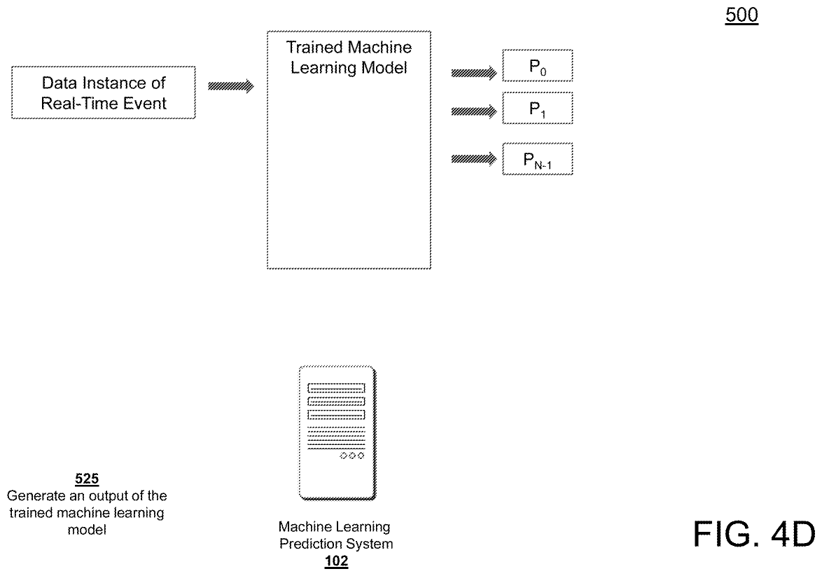

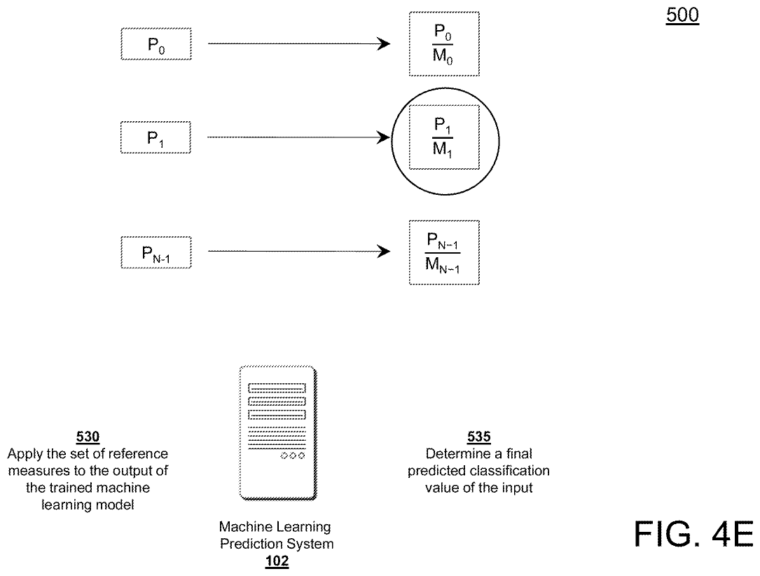

Referring now to FIGS. 4A-4E, FIGS. 4A-4E are diagrams of an implementation 500 of a process (e.g., process 300) for tuning prediction results of a machine learning model to provide a prediction of clearing time for a payment transaction. As illustrated in FIGS. 4A-4E, implementation 500 may include machine learning prediction system 102 performing the steps of the process. In some non-limiting embodiments or aspects, the steps of the process shown in FIGS. 4A-4E may be associated with a trained machine learning model.

As shown by reference number 510 in FIG. 4A, machine learning prediction system 102 may generate a prediction matrix based on outputs of a trained machine learning model. In some non-limiting embodiments or aspects, machine learning prediction system 102 may determine a plurality of classification values associated with the prediction matrix based on outputs (e.g., predicted classification values of inputs) of the trained machine learning model.

In some non-limiting embodiments or aspects, the plurality of classification values associated with the prediction matrix may include values representing an error value between a predicted classification value of an amount of time, such as a number of days, for clearing of a plurality of electronic payment transactions and a ground truth classification value of an amount of time for clearing of the plurality of electronic payment transactions. In some non-limiting embodiments or aspects, the plurality of values associated with the prediction matrix may include upper error values for the plurality of electronic payment transactions and lower error values for the plurality of electronic payment transactions. In some non-limiting embodiments or aspects, the upper error values may include error values associated with the predicted classification value of an amount of time (e.g., a number of days) for clearing of the plurality of electronic payment transactions being greater than the ground truth classification value of the amount of time for clearing of the plurality of electronic payment transactions. In some non-limiting embodiments or aspects, the lower error values comprise error values associated with the predicted classification value of an amount of time for clearing of the plurality of electronic payment transactions being less than the ground truth classification value of the amount of time for clearing of the plurality of electronic payment transactions.

In some non-limiting embodiments or aspects, the trained machine learning model may be configured to provide an output associated with a plurality of class labels (e.g., a plurality of labels for a plurality of predicted classification values). For example, the trained machine learning model may be configured to provide an output associated with the plurality of class labels that correspond to classification values of the prediction matrix. In some non-limiting embodiments or aspects, the plurality of class labels may include a first class label associated with a predicted classification value of zero days for clearing of an electronic payment transaction, a second class label associated with a predicted classification value of one day for clearing of an electronic payment transaction, a third class label associated with a predicted classification value of two days for clearing of an electronic payment transaction, and a fourth class label associated with a predicted classification value of three or more days for clearing of an electronic payment transaction.

As shown in FIG. 4A, the values of the prediction matrix may include an error value between a first ground truth value (e.g., 0 days for clearing an electronic payment transactions) for one or more data instances and a first predicted classification value (e.g., 0 days for clearing an electronic payment transactions) for the one or more data instances, an error value between a second ground truth value (e.g., 1 day for clearing an electronic payment transactions) for one or more data instances and the first predicted classification value (e.g., 0 days for clearing an electronic payment transactions) for the one or more data instances, an error value between the first ground truth value (e.g., 0 days for clearing an electronic payment transactions) for one or more data instances and a second predicted classification value (e.g., 1 day for clearing an electronic payment transactions) for the one or more data instances, an error value between a third ground truth value (e.g., 2 days for clearing an electronic payment transactions) for one or more data instances and the first predicted classification value (e.g., 0 days for clearing an electronic payment transactions) for the one or more data instances, an error value between the first ground truth value for one (e.g., 0 days for clearing an electronic payment transactions) or more data instances and a third predicted classification value (e.g., 2 days for clearing an electronic payment transactions) for the one or more data instances, an error value between the third ground truth value (e.g., 2 days for clearing an electronic payment transactions) for one or more data instances and the second predicted classification value (e.g., 1 day for clearing an electronic payment transactions) for the one or more data instances, an error value between the second ground truth value (e.g., 1 day for clearing an electronic payment transactions) for one or more data instances and the third predicted classification value (e.g., 2 days for clearing an electronic payment transactions) for the one or more data instances, and the like. In some non-limiting embodiments or aspects, the plurality of values associated with the prediction matrix may include upper error values (e.g., values shown as “UE_[XY]”, where “X” denotes the ground truth classification value and “Y” denotes the predicted classification value) for a plurality of events, lower error values (e.g., values shown as “LE_[XY]”, where “X” denotes the ground truth classification value and “Y” denotes the predicted classification value) for the plurality of events, and correct prediction values (e.g., values shown as “CP_[XY]”, where “X” denotes the ground truth classification value and “Y” denotes the predicted classification value). In some non-limiting embodiments or aspects, the upper error values comprise error values associated with the predicted classification value for the event being greater than the ground truth value for the event. In some non-limiting embodiments or aspects, the lower error values may include error values associated with the predicted classification value for the event being less than the ground truth value for the event. In some non-limiting embodiments or aspects, the plurality of values associated with the prediction matrix may include correct prediction values, which may include values associated with the predicted classification value for the event being equal to the ground truth value for the event.

In some non-limiting embodiments or aspects, machine learning prediction system 102 may train a multi-class deep learning model based on a training dataset used to generate the trained machine learning model, the training dataset may include a plurality of data instances that correspond to a plurality of electronic payment transactions (e.g., a plurality of electronic payment transactions upon which the plurality of classification values associated with the prediction matrix is based).

As shown by reference number 515 in FIG. 4B, machine learning prediction system 102 may generate a set of reference measures. In some non-limiting embodiments or aspects, machine learning prediction system 102 may determine initial values of the set of reference measures. In some non-limiting embodiments or aspects, the set of reference measures may include a vector (e.g., a reference measure vector) with a set of values:

$$\{ {M}_{0} , {M}_{1} , … {M}_{N - 1} \}$$

In some non-limiting embodiments or aspects, each value of the set of values of the vector may be determined to adjust a predicted classification value of a prospective output of the trained machine learning model to reduce the lower error rate.

In some non-limiting embodiments or aspects, machine learning prediction system 102 may tune the set of reference measures to provide an adjustment to a predicted classification value of a prospective output of the trained machine learning model. In some non-limiting embodiments or aspects, when tuning the set of reference measures to provide the adjustment to the predicted classification value of a prospective output of the trained machine learning model, machine learning prediction system 102 may adjust the predicted classification value of the prospective output of the trained machine learning model to reduce a percentage of lower error values in the plurality of classification values associated with the prediction matrix. In some non-limiting embodiments or aspects, the set of reference measures may include a number of values that is equal to a number of a plurality of class labels associated with an output of the trained machine learning model. In some non-limiting embodiments or aspects, each reference measure in the set of reference measures may have a value between 0 and 1, and the values of the reference measures in the set of reference measures may be equal to 1 when summed together.

In some non-limiting embodiments or aspects, machine learning prediction system 102 may calculate a lower error rate based on the upper error values for the plurality of electronic payment transactions, the lower error values for the plurality of electronic payment transactions, and/or correct prediction values for the plurality of electronic payment transactions. In some non-limiting embodiments or aspects, when tuning the set of reference measures to provide the adjustment to the predicted classification value of the prospective output of the trained machine learning model, machine learning prediction system 102 may tune the set of reference measures to provide the adjustment to the predicted classification value of the prospective output of the trained machine learning model based on the lower error rate.

As shown by reference number 520 in FIG. 4C, machine learning prediction system 102 may provide an input to the trained machine learning model. In some non-limiting embodiments or aspects, the input may include a data instance of a real-time event, such as a real-time electronic payment transaction. As shown by reference number 525 in FIG. 4D, machine learning prediction system 102 may generate an output of the trained machine learning model. In some non-limiting embodiments or aspects, the output of the trained machine learning model may include a plurality of predicted classification values, P₀, P₁, and P_{N-1}.

As shown by reference number 530 in FIG. 4E, machine learning prediction system 102 may apply the set of reference measures to the output of the trained machine learning model. For example, machine learning prediction system 102 may perform an operation on the plurality of predicted classification values of the output of the trained machine learning using the set of reference measures. In some non-limiting embodiments or aspects, machine learning prediction system 102 may divide each predicted classification value of the plurality of predicted classification values by a corresponding value of the vector of the set of reference measures to provide a plurality of adjusted predicted classification values for the real-time electronic payment transaction.

As shown by reference number 535 in FIG. 4E, machine learning prediction system 102 may determine a final predicted classification value (e.g., a final predicted amount of time for clearing an electronic payment transaction) for the input. In some non-limiting embodiments or aspects, machine learning prediction system 102 may determine the final predicted classification value of the output based on an adjusted predicted classification value of the plurality of adjusted predicted classification values that has the highest value (e.g., the highest score). In some non-limiting embodiments or aspects, machine learning prediction system 102 may generate a report that includes data associated with the final predicted amount of time for clearing, such as a predicted number of days for clearing, the real-time electronic payment transaction, and machine learning prediction system 102 may transmit the report. In some non-limiting embodiments or aspects, machine learning prediction system 102 may transmit the report to issuer system 106 and/or merchant system 108.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

1. A system, comprising:
at least one processor programmed or configured to:
determine a plurality of values associated with a prediction matrix based on a first output of a trained machine learning model, wherein the plurality of values associated with the prediction matrix are values representing an error value between a predicted classification value for each event of a plurality of events and a ground truth value for each event of the plurality of events, wherein the plurality of values associated with the prediction matrix comprise:
upper error values for the plurality of events and lower error values for the plurality of events,
wherein the upper error values comprise error values associated with the predicted classification value for the plurality of events being greater than the ground truth value for the plurality of events, and
wherein the lower error values comprise error values associated with the predicted classification value for the plurality of events being less than the ground truth value for the plurality of events;
tune a set of reference measures to provide an adjustment to a predicted classification value of a prospective output of the trained machine learning model, wherein, when tuning the set of reference measures to provide the adjustment to the predicted classification value of the prospective output of the trained machine learning model, the at least one processor is programmed or configured to:
adjust the predicted classification value of the prospective output of the trained machine learning model to reduce one or more lower error values in the plurality of values associated with the prediction matrix; and
apply the set of reference measures to determine a predicted classification value of a second output of the trained machine learning model, wherein the second output of the trained machine learning model comprises a prediction for an event.

2. The system of claim 1, wherein the set of reference measures comprises a reference measure vector with a set of values, wherein the second output of the trained machine learning model comprises an output vector with a set of values, and wherein, when applying the set of reference measures to determine the predicted classification value of the second output of the trained machine learning model, the at least one processor is programmed or configured to:
multiply the set of values of the output vector by the set of values of the reference measure vector to provide an adjusted output vector.

3. The system of claim 2, wherein the at least one processor is further programmed or configured to:
determine the predicted classification value of the second output of the trained machine learning model based on the adjusted output vector.

4. The system of claim 1, wherein the at least one processor is further programmed or configured to:
train a multi-class deep learning model based on a training dataset used to generate the trained machine learning model, wherein the training dataset comprises a plurality of data instances associated with the plurality of events.

5. The system of claim 1, wherein the set of reference measures comprises a number of values that is equal to a number of a plurality of class labels associated with the second output of the trained machine learning model.

6. The system of claim 5, wherein each reference measure in the set of reference measures has a value between 0 and 1, and wherein values of the reference measures in the set of reference measures are equal to 1 when summed together.

7. The system of claim 1, wherein the at least one processor is further programmed or configured to:
calculate a lower error rate based on the upper error values for the plurality of events, the lower error values for the plurality of events, and correct prediction values for the plurality of events; and
wherein, when tuning the set of reference measures to provide the adjustment to the predicted classification value of the prospective output of the trained machine learning model, the at least one processor is programmed or configured to:
tune the set of reference measures to provide the adjustment to the predicted classification value of the prospective output of the trained machine learning model based on the lower error rate.

8. A computer program product comprising at least one non-transitory computer-readable medium including one or more instructions that, when executed by at least one processor, cause the at least one processor to:
determine a plurality of values associated with a prediction matrix based on a first output of a trained machine learning model, wherein the plurality of values associated with the prediction matrix are values representing an error value between a predicted classification value for each event of a plurality of events and a ground truth value for each event of the plurality of events, wherein the plurality of values associated with the prediction matrix comprise:
upper error values for the plurality of events and lower error values for the plurality of events,
wherein the upper error values comprise error values associated with the predicted classification value for the plurality of events being greater than the ground truth value for the plurality of events, and
wherein the lower error values comprise error values associated with the predicted classification value for the plurality of events being less than the ground truth value for the plurality of events;
tune a set of reference measures to provide an adjustment to a predicted classification value of a prospective output of the trained machine learning model, wherein the one or more instructions that cause the at least one processor to tune the set of reference measures to provide the adjustment to the predicted classification value of the prospective output of the trained machine learning model, cause the at least one processor to:
adjust the predicted classification value of the prospective output of the trained machine learning model to reduce one or more lower error values in the plurality of values associated with the prediction matrix; and
apply the set of reference measures to determine a predicted classification value of a second output of the trained machine learning model, wherein the second output of the trained machine learning model comprises a prediction for an event.

9. The computer program product of claim 8, wherein the set of reference measures comprises a reference measure vector with a set of values, wherein the second output of the trained machine learning model comprises an output vector with a set of values, and wherein the one or more instructions that cause the at least one processor to apply the set of reference measures to determine the predicted classification value of the second output of the trained machine learning model, cause the at least one processor to:
multiply the set of values of the output vector by the set of values of the reference measure vector to provide an adjusted output vector.

10. The computer program product of claim 9, wherein the one or more instructions further cause the at least one processor to:
determine the predicted classification value of the second output of the trained machine learning model based on the adjusted output vector.

11. The computer program product of claim 8, wherein the one or more instructions further cause the at least one processor to:
train a multi-class deep learning model based on a training dataset used to generate the trained machine learning model, wherein the training dataset comprises a plurality of data instances associated with the plurality of events.

12. The computer program product of claim 8, wherein the set of reference measures comprises a number of values that is equal to a number of a plurality of class labels associated with the second output of the trained machine learning model.

13. The computer program product of claim 12, wherein each reference measure in the set of reference measures has a value between 0 and 1, and wherein values of the reference measures in the set of reference measures are equal to 1 when summed together.

14. The computer program product of claim 8, wherein the one or more instructions further cause the at least one processor to:
calculate a lower error rate based on the upper error values for the plurality of events, the lower error values for the plurality of events, and correct prediction values for the plurality of events; and
wherein the one or more instructions that cause the at least one processor to tune the set of reference measures to provide the adjustment to the predicted classification value of the prospective output of the trained machine learning model, cause the at least one processor to:
tune the set of reference measures to provide the adjustment to the predicted classification value of the prospective output of the trained machine learning model based on the lower error rate.

15. A method, comprising:
determining, with at least one processor, a plurality of values associated with a prediction matrix based on a first output of a trained machine learning model, wherein the plurality of values associated with the prediction matrix are values representing an error value between a predicted classification value for each event of a plurality of events and a ground truth value for each event of the plurality of events, wherein the plurality of values associated with the prediction matrix comprise:
upper error values for the plurality of events and lower error values for the plurality of events,
wherein the upper error values comprise error values associated with the predicted classification value for the plurality of events being greater than the ground truth value for the plurality of events, and
wherein the lower error values comprise error values associated with the predicted classification value for the plurality of events being less than the ground truth value for the plurality of events;
tuning, with the at least one processor, a set of reference measures to provide an adjustment to a predicted classification value of a prospective output of the trained machine learning model, wherein tuning the set of reference measures to provide the adjustment to the predicted classification value of the prospective output of the trained machine learning model comprises:
adjusting the predicted classification value of the prospective output of the trained machine learning model to reduce one or more lower error values in the plurality of values associated with the prediction matrix; and
applying the set of reference measures to determine a predicted classification value of a second output of the trained machine learning model, wherein the second output of the trained machine learning model comprises a prediction for an event.

16. The method of claim 15, wherein the set of reference measures comprises a reference measure vector with a set of values, wherein the second output of the trained machine learning model comprises an output vector with a set of values, and wherein applying the set of reference measures to determine the predicted classification value of the second output of the trained machine learning model comprises:
multiplying the set of values of the output vector by the set of values of the reference measure vector to provide an adjusted output vector.

17. The method of claim 16, further comprising:
determining the predicted classification value of the second output of the trained machine learning model based on the adjusted output vector.

18. The method of claim 15, further comprising:
training, with the at least one processor, a multi-class deep learning model based on a training dataset used to generate the trained machine learning model, wherein the training dataset comprises a plurality of data instances associated with the plurality of events.

19. The method of claim 15, wherein the set of reference measures comprises a number of values that is equal to a number of a plurality of class labels associated with the second output of the trained machine learning model.

20. The method of claim 15, further comprising:
calculating, with the at least one processor, a lower error rate based on the upper error values for the plurality of events, the lower error values for the plurality of events, and correct prediction values for the plurality of events; and
wherein tuning the set of reference measures to provide the adjustment to the predicted classification value of the prospective output of the trained machine learning model comprises:
tuning the set of reference measures to provide the adjustment to the predicted classification value of the prospective output of the trained machine learning model based on the lower error rate.
